(19) United States
(12) Patent Application Publication
(10) Pub. No.: US 2008/0222088 A1
(43) Pub. Date: Sep. 11, 2008

(54) Apparatus and Methods for Generating an Implicit Vote for a Media Item Based on User Behavior Relative to a Media Client

(75) Inventors: Tzvetan T. Horozov, Hoffman Estates, IL (US); Jay R. Almaula, Bartlett, IL (US); Nitya Narasimhan, Lake Zurich, IL (US); Jean Marc A. Villevieille, Phoenix, AZ (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/684,000

(22) Filed: Mar. 8, 2007

(51) Int. Cl. G06F 17/30; G06F 7/00

(52) U.S. Cl. 707/2; 707/E17.032

(57) ABSTRACT

A method of generating an implicit vote for a media item based on user behavior may comprise recording information identifying a first set of user inputs to a media client associated with playing of a first media item, receiving and storing an explicit vote for the first media item, and storing information that correlates a user input from the first set of user inputs with the explicit vote. The first set of user inputs may comprise at least one user input. The method may comprise recording information identifying a second set of user inputs to the media client associated with playing of a second media item, wherein the second set of user inputs may comprise at least one user input matching the stored correlated user input. The method may comprise generating an implicit vote for the second media item based on the stored information correlating the stored correlated user input with the explicit vote.

### TECHNICAL FIELD

The present invention is directed to the registering of a user vote for a media item. More particularly, the present invention is directed to methods and apparatus for generating an implicit vote for a media item based on user behavior relative to a media client.

### BACKGROUND

Recommendation systems are popular tools that use information filtering techniques in order to try to predict the items that a user is likely to enjoy best. Companies like Amazon, TiVo, and Apple have long used collaborative filtering recommendations in order to increase sales by recommending relevant items for each user. The basic technique for recommendation relies on the premise that similar users vote similarly on similar items. A recommendation system can then try to predict whether a given user will like a given item by considering how similar users have voted on the same item. The pool of similar users can be determined based on previous usage habits, previous purchases, demographics, etc.

One of the most important requirements for an accurate prediction is to have sufficient voting data across the entire population of users. The more user votes the system has, the stronger the prediction capabilities will be. Unfortunately users are not always willing to cast a vote on a given item. User participation may be a function of how difficult voting is. Some systems, for example, TiVo, have thus resorted to a one-click thumbs up/thumbs down technique that make it really easy for users to cast a vote on a given item. Nevertheless, such techniques still requires user commitment and, thus, the number of collected votes may still be limited. Other systems, for example, Yahoo! LAUNCHcast, use tools that ask users to specifically rate a music item on a scale 1-100. Such systems definitely require extensive user participation for the recommendation system to work properly.

Still other systems, for example, Amazon, consider a user's actions, for example, entries into a shopping cart, to conclude that the user likes certain items. Such systems may be generally able to deduce the positive votes that users cast for different items but are usually unable to infer any negative votes. Thus, the predicting power of the recommendations is limited to the parameters of the positive votes, irrespective of potential negative votes.

It may be desirable to provide a system that automatically generates votes for media items that a user watches and/or listens to without the need for any explicit participation. Such system may increase the voting rate of users, which in turn may improve the predictions of conventional recommendation algorithms.

### SUMMARY OF THE INVENTION

According to various aspects of the disclosure, a method of generating an implicit vote for a media item based on user behavior may comprise recording information identifying a first set of user inputs to a media client associated with playing of a first media item, receiving and storing an explicit vote for the first media item, and storing information that correlates a user input from the first set of user inputs with the explicit vote. The first set of user inputs may comprise at least one user input. The method may comprise recording information identifying a second set of user inputs to the media client associated with playing of a second media item, wherein the second set of user inputs may comprise at least one user input matching the stored correlated user input. The method may comprise generating an implicit vote for the second media item based on the stored information correlating the stored correlated user input with the explicit vote.

In accordance with some aspects of the disclosure, a method of generating an implicit vote for a media item based on user behavior may comprise populating a mapping table with information correlating a user input with an explicit vote and recording information identifying a set of user inputs to the media client associated with playing of a media item. The set of user inputs may comprise at least one user input matching the user input in the mapping table. The method may comprise generating an implicit vote for the media item based on the stored information correlating the stored correlated user input with the explicit vote.

In some aspects of the disclosure, a communication device may comprise a transceiver configured to send and receive signals, a media client configured to output a media item, and an implicit vote generation module. The implicit vote generation module may be configured to record information identifying a first set of user inputs to the media client associated with playing of a first media item, receive and store an explicit vote for the first media item, and store information that correlates a user input from the first set of user inputs with the explicit vote. The first set of user inputs may comprise at least one user input. The implicit vote generation module may be configured to record information identifying a second set of user inputs to the media client associated with playing of a second media item, wherein the second set of user inputs comprising at least one user input matching the stored correlated user input, and generate an implicit vote for the second media item based on the stored information correlating the stored correlated user input with the explicit vote.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of an implicit vote generation module operating in a communications network in accordance with a possible embodiment of the invention;

FIG. 2 illustrates a block diagram of an exemplary wireless communication device having an implicit vote generation module in accordance with a possible embodiment of the invention;

FIG. 3 is a block diagram showing exemplary modules of an exemplary implicit vote generation module in accordance with a possible embodiment of the invention; and

FIG. 4 is an exemplary flowchart illustrating one possible implicit vote generation process in accordance with one possible embodiment of the invention.

### DETAILED DESCRIPTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used.

The present invention comprises a variety of embodiments, such as methods and apparatus and other embodiments that relate to the basic concepts of the invention.

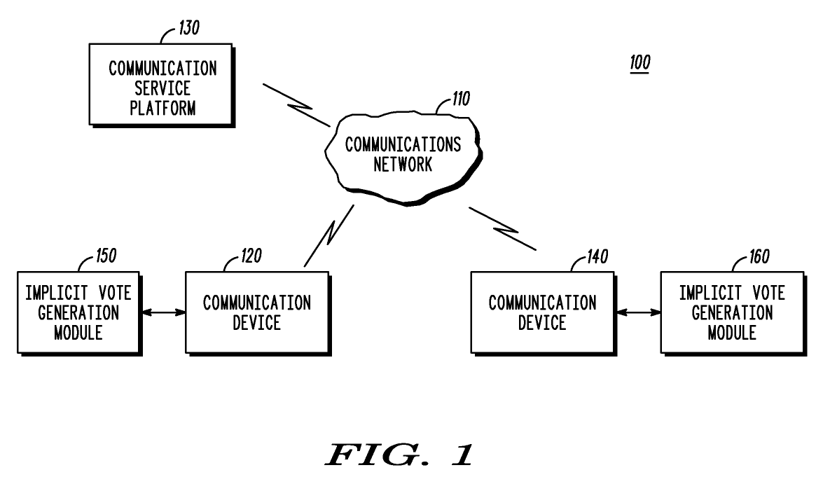

FIG. 1 illustrates an implicit vote generation module 150 operating in a communications network environment 100. The communications network environment 100, for example, a wireless communications system, includes communications network 110, a first wireless communication device 120, a communications service platform 130, and a second wireless communication device 140. The implicit vote generation module 150 is coupled to the first wireless communication device 120. A second implicit vote generation module 160 may be coupled to the second wireless communication device 140.

Communications network 110 may represent any network known to one of skill in the art, including a wireless telephone network, cellular network, a wired telephone network, the Internet, wireless computer network, intranet, satellite radio network, etc. Wireless communication devices 120, 140 may represent wireless telephones, wired telephones, personal computers, portable radios, personal digital assistants (PDAs), MP3 players, satellite radio, satellite television, a global positioning system (GPS) receiver, etc.

The communications network 110 may allow first wireless communication device 120 to communicate with a communications service platform 130 that may provide services such as media content, navigation, directory information, etc. to GPS devices, satellite radios, MP3 players, PDAs, radios, satellite televisions, etc. First wireless communication device 120 may communicate through communications network 110 with other wireless communication devices, such as second wireless communication device 140.

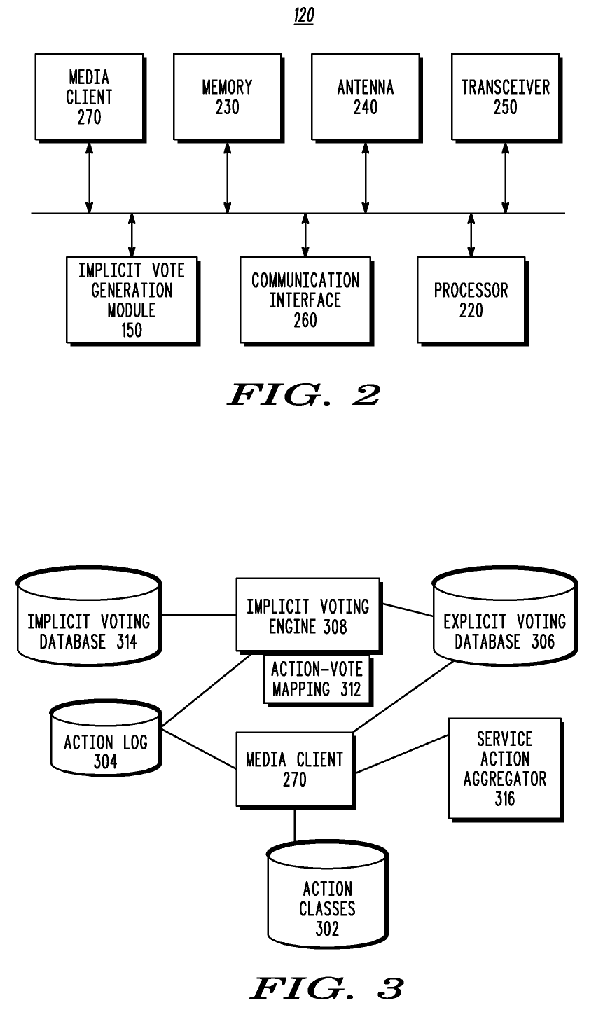

FIG. 2 illustrates a block diagram of an exemplary wireless communication device 120 having an implicit vote generation module 150 in accordance with a possible embodiment of the invention. The exemplary wireless communication device 120 may include a bus 210, a processor 220, a memory 230, an antenna 240, a transceiver 250, a communication interface 260, a media client 270, and the implicit vote generation module 150. Bus 210 may permit communication among the components of the wireless communication device 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within the communications network 110.

Communication interface 260 may include any mechanism that facilitates communication via the communications network 110. For example, communication interface 260 may include a modem. Alternatively, communication interface 260 may include other mechanisms for assisting the transceiver 250 in communicating with other devices and/or systems via wireless connections.

The wireless communication device 120 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 260.

The media client 270 may comprise, for example, a media playing device such as, for example, an iRadio client, and may provide one or more user interfaces that allow users to input the following actions with respect to media items: fast forward, rewind, skip, repeat, volume increase, volume decrease, channel skip, etc. Each such action may correspond to a physical user interface such as a button on the media client 270, a menu item on a graphical user interface of the media client 270, and/or a voice activation command receivable by the media client 270 via a voice activation interface.

FIG. 3 illustrates a block diagram of an exemplary implicit vote generation module 150 and media client 270 in accordance with a possible embodiment of the invention. The implicit vote generation module 150 may include an action classes database 302 configured to store all possible actions that can be taken by a user relative to the media client 270. For example, with respect to a media item being played by the media client 270, the user may be able to fast forward, rewind, skip, repeat, increase volume, decrease volume, channel skip, etc. The database 302 maybe populated from a centralized service provider, for example, via the communications networks 110, and may contain actions that are specific for a given device.

The implicit vote generation module 150 may include an action log database 304. Once the user starts using the media client 270, all user inputs, for example, button clicks, menu presses, and/or voice commands, may be monitored and stored in the action log database 304. Along with a description of the action (i.e., user input) that a user has taken on the media client 270, each entry of the database 304 may contain information about the identity of the user as well as the identity of the media item to which the user input pertains.

The implicit vote generation module 150 may include an explicit voting database 306 configured to store votes that are explicitly cast by a user for particular media items. The explicit votes may include positive votes and/or negative votes. The explicit votes may include various levels of positives and/or negatives, such as, for example, two thumbs up, one thumb up, one thumb down, two thumbs down, or any other variation of levels.

An implicit voting engine 308 may be configured to monitor the user inputs stored at the action log database 304 and, based on correlations between the stored explicit votes for particular media items and the stored user inputs for those same particular media items, create an action vote mapping table 312. For example, some stored user inputs such as, for example, rewind, repeat, and increase volume may be correlated with positive votes. On the other hand, some stored user inputs such as, for example, fast forward, skip, decrease volume, and channel skip may be correlated with negative votes.

According to various aspects, the action vote mapping table 312 may be created uniquely for each user of a media client 270. Using the mapping rules of the action vote mapping table, the implicit vote generation module 150 may be configured to map subsequent user inputs to implicit votes by referring to stored explicit votes for user inputs matching those of the subsequent user inputs. The implicit vote generation module 150 may be configured to implicitly cast the mapped vote on behalf of the user. The implicitly cast votes may be stored in an implicit voting database 314. As with the stored explicit votes, the implicit votes may include various levels of positives and/or negatives, such as, for example, two thumbs up, one thumb up, one thumb down, two thumbs down, or any other variation of levels.

According to various aspects of the disclosure, a service action aggregator 316 may be configured to monitor the action vote mapping table 312 and detect patterns across the population of users in order to identify action-vote mappings that could be applied to the entire population. For example, if everyone, after increasing the volume of a media item voted positively for that item, the aggregator 316 can use that rule and populate the mapping table 312 for all users. In this way, the implicit vote generation module 150 can generate implicit votes on behalf of a user, even if that user has not cast any explicit vote.

The communications network 110, the wireless communication device 120, and the implicit vote generation module 150 illustrated in FIGS. 1-3 and the related discussion are intended to provide a brief, general description of a suitable computing environment in which the invention may be implemented. Although not required, the invention will be described, at least in part, in the general context of computer-executable instructions, such as program modules, being executed by the wireless communication device 120, such as a communications server or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types and combinations of communication equipment and computer system configurations, including cellular devices, mobile communication devices, personal computers, hand-held devices, multi-processor systems, microprocessor-based or programmable consumer electronics, and the like. For example, an embodiment can be practiced in a communication network that includes a personal computer and a mobile telephone configured to communicate with one another.

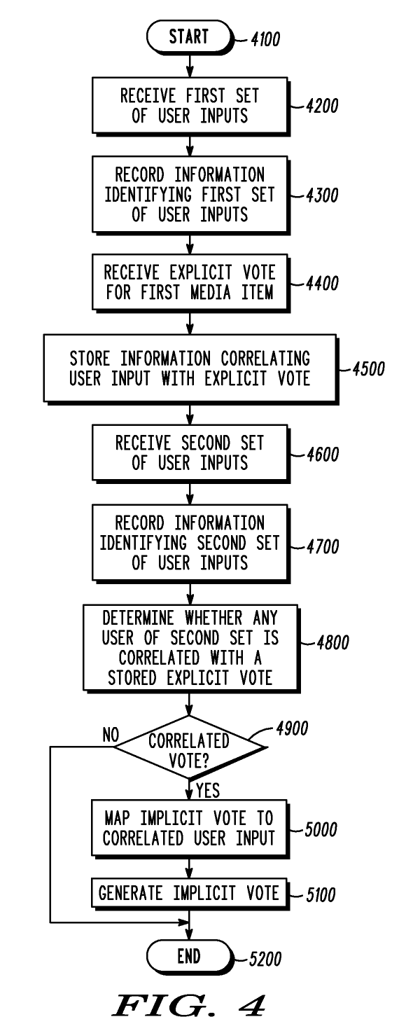

For illustrative purposes, an exemplary implicit vote generation process will be described below in relation to the block diagrams shown in FIGS. 1-3. FIG. 4 is an exemplary flowchart illustrating some of the basic steps associated with an implicit vote generation process in accordance with a possible embodiment of the invention. The process begins at step 4100 when a media client 270 outputs a media item and continues to step 4200 where a first set of user inputs to the media client 270 are received. Then in step 4300, information identifying the first set of user inputs to the media client 270 is recorded, for example, via storing in the action log database 304. The first set of user inputs are associated with playing of a first media item, such as, for example, a song, a video, etc. The first set of user inputs comprises at least one user input for an action, such as, for example, fast forward, rewind, skip, repeat, volume increase, volume decrease, channel skip, etc. Control proceeds to step 4400.

In step 4400, an explicit vote for the first media item is received from the user and stored, for example, in the explicit voting database 306. Control continues to step 4500 where information correlating at least one user input from the first set of user inputs with the explicit vote for the first media item is stored, for example, in the action vote mapping table 312. According to some aspects of the disclosure, the action vote mapping table 312 may be populated with information from other users via other media clients. The action vote mapping table 312 may be populated before or after storing the information correlating the user input from the first set of user inputs with the explicit vote. Control proceeds to step 4600.

Next, in step 4600, a second set of user inputs to the media client 270 are received. Then in step 4700, information identifying the second set of user inputs to the media client 270 is recorded, for example, via storing in the action log database 304. The second set of user inputs are associated with playing of a second media item, such as, for example, a song, a video, etc. The second set of user inputs comprises at least one user input for an action, such as, for example, fast forward, rewind, skip, repeat, volume increase, volume decrease, channel skip, etc. Control proceeds to step 4800.

In step 4800, the implicit voting engine 308 determines whether any of the user inputs from the second set of user inputs is correlated with a vote via the action vote mapping table 312. Control continues to step 4900. In step 4900, if it is determined that a user input from the second set of user inputs is correlated to a vote in the mapping table 312, control proceeds to step 5000, where an implicit vote is mapped to the correlated user input. Control then continues to step 5100, where the implicit vote is generated by the implicit voting generation module 150. The generated implicit vote may be output, for example, to a media recommendation engine (not shown) via the communications network 110. The media recommendation engine may comprise any recommendation engine known in the art that detects user interests and recommends additional media selections based thereon. Control proceeds to step 5200 where the process ends.

If, in step 4900, it is determined that no user input from the second set of user is correlated to a vote in the mapping table, control skips to step 5200 where the process ends.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It is noted that, as used in this specification and the appended claims, the singular forms “a,” “an,” and “the,” include plural referents unless expressly and unequivocally limited to one referent. Thus, for example, reference to “a user input” includes two or more different user inputs. As used herein, the term “include” and its grammatical variants are intended to be non-limiting, such that recitation of items in a list is not to the exclusion of other like items that can be substituted or other items that can be added to the listed items.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A method of generating an implicit vote for a media item based on user behavior, comprising:
recording information identifying a first set of user inputs to a media client associated with playing of a first media item, the first set of user inputs comprising at least one user input;
receiving and storing an explicit vote for the first media item;
storing information that correlates a user input from the first set of user inputs with the explicit vote;
recording information identifying a second set of user inputs to the media client associated with playing of a second media item, the second set of user inputs comprising at least one user input matching the stored correlated user input; and
generating an implicit vote for the second media item based on the stored information correlating the stored correlated user input with the explicit vote.

2. The method of claim 1, wherein the step of storing information comprises populating a mapping table with the information that correlates a user input with an explicit vote.

3. The method of claim 2, further comprising, before generating an implicit vote, determining whether a user input from the second set of user inputs can be mapped to an implicit vote via the mapping table.

4. The method of claim 2, further comprising populating the mapping table with information received from other users.

5. The method of claim 1, further comprising outputting the generated implicit vote.

6. The method of claim 1, further comprising receiving the user inputs of the first and second sets of user inputs via at least one of a physical user interface, a graphical user interface, and a voice-activated user interface.

7. A method of generating an implicit vote for a media item based on user behavior, comprising:
populating a mapping table with information correlating a user input with an explicit vote;
recording information identifying a set of user inputs to the media client associated with playing of a media item, the set of user inputs comprising at least one user input matching the user input in the mapping table; and
generating an implicit vote for the media item based on the stored information correlating the stored correlated user input with the explicit vote.

8. The method of claim 7, wherein the step of populating comprises populating the mapping table with information received from other users.

9. The method of claim 7, wherein the step of populating comprises:
recording information identifying a first set of user inputs to a media client associated with playing of a first media item, the first set of user inputs comprising at least one user input;
receiving and storing an explicit vote for the first media item; and
storing information that correlates a user input from the first set of user inputs with the explicit vote.

10. The method of claim 9, further comprising receiving the user inputs of the set of user inputs and the first set of user inputs via at least one of a physical user interface, a graphical user interface, and a voice-activated user interface.

11. The method of claim 7, further comprising, before generating an implicit vote, determining whether a user input from the set of user inputs can be mapped to an implicit vote via the mapping table.

12. The method of claim 7, further comprising outputting the generated implicit vote.

13. A communication device, comprising:
a transceiver configured to send and receive signals;
a media client configured to output a media item; and
an implicit vote generation module configured to record information identifying a first set of user inputs to the media client associated with playing of a first media item, the first set of user inputs comprising at least one user input; receive and store an explicit vote for the first media item; store information that correlates a user input from the first set of user inputs with the explicit vote; record information identifying a second set of user inputs to the media client associated with playing of a second media item, the second set of user inputs comprising at least one user input matching the stored correlated user input; and generate an implicit vote for the second media item based on the stored information correlating the stored correlated user input with the explicit vote.

14. The device of claim 13, further comprising a mapping table populated with the stored information that correlates a user input with an explicit vote.

15. The device of claim 13, wherein the implicit vote generation module is further configured to, before generating an implicit vote, determine whether a user input from the second set of user inputs can be mapped to an implicit vote via the mapping table.

16. The device of claim 13, wherein the implicit vote generation module is configured to populate the mapping table with information received from other users.

17. The device of claim 13, wherein the implicit vote generation module is further configured to output the generated implicit vote.

18. The device of claim 13, wherein the media client comprises at least one of a physical user interface, a graphical user interface, and a voice-activated user interface configured to receive the user inputs of the first and second sets of user inputs.

19. The device of claim 13, wherein the media client comprises a media playing device associated with one of a wireless telephone, wired telephone, personal computer, portable radio, personal digital assistant, MP3 player, satellite radio, satellite television, and a global positioning system receiver.

20. The device of claim 13, wherein the transceiver is configured to send and receive signals wirelessly.
